(19) United States
(12) Patent Application Publication
(10) Pub. No.: US 2003/0020848 A1
(43) Pub. Date: Jan. 30, 2003

(54) Display device having an LC light modulator element arranged in front of it

(76) Inventors: Dirk Jan Broer, Eindhoven (NL); Roel Penterman, Eindhoven (NL)

Correspondence Address: U.S. Philips Corporation, 580 White Plains Road, Tarrytown, NY, 10591, US

(21) Appl. No.: 10/198,784

(22) Filed: Jul. 19, 2002

(30) Foreign Application Priority Data
Jul. 24, 2001 (EP) 01202839.5

(51) Int. Cl. G02F 1/1335

(52) U.S. Cl. 349/61

(57) ABSTRACT

Display device having a display panel with an active part on which pictures are displayed, a stratified (LC) light modulator element (e.g. a shutter or a switch) of a size corresponding to the size of the active part of the display panel being arranged in front of the display panel, the light modulator element being provided with transparent electrode means for energizing the LC light modulator element. The stratified LC light modulator element comprises:

a transparent substrate which carries a composite material phase separated into a light-modulating layer comprising liquid crystal material disposed adjacent the substrate, and a top layer of organic material, inorganic material, or a mixture of organic and inorganic material disposed adjacent the display panel, the LC light modulator element being laminated to the surface of the display panel.

The invention relates to a display device having a display panel with an active part on which pictures are displayed, an L(iquid) C(rystal) light modulator element of a size corresponding to the size of the active part of the display panel being arranged in front of the display panel, the light modulator element being provided with transparent electrode means allowing energization of the LC light modulator element. The light modulator element will hereinafter be mostly referred to as LC shutter, but sometimes also as “light modulator”, or as “switch”.

It is known that picture display devices, like CRTs, Plasma Displays (PDPs), LCDs, when not in operation have an appearance which is not in harmony with their surroundings. A solution to this problem is described in JP-A 4-132380. In this publication, the outer periphery of an LC cell, which functions as an LC shutter is held by an attaching frame, and the assembly is attached to the front face of the CRT in a television receiver. The LC material in the cell is arranged between electrodes which are turned to a state in which power is supplied in accordance with the on/off operation of the power source of the television receiver. The LC cell is thereby turned to the transparent state when the television receiver is operative and to a light-absorbing state when the receiver is inoperative.

A special embodiment of an LC shutter is the scanning window, the concept of which is described in EP-A 0 000 422.

In general, a display device comprises a display window. The image is displayed on the display window. The display window comprises means for selectively generating light at areas of the display window. In a CRT, for instance, the image is built up line by line.

A major problem for display devices is the reflection of ambient light on the display window or at components of the display device such as phosphor elements (in e.g. CRTs and PDPs). Apart from the image generated by the device, the viewer also sees reflections of other light sources, such as lamps and/or the sun shining on the display window. The reflections of such external light sources (i.e. sources outside the display device) reduces the contrast of the image displayed, and can even make it invisible especially when bright sunlight shines on the display window. Many solutions have been proposed, ranging from reducing the light intensity in the room, reducing the reflection coefficient of the surfaces of the display window (anti-reflection coatings) and using dark glass for the window (the latter reduces the reflection on the inner side of the display window).

It is known from European patent application no. 0 000 422 to use a means for transmitting light from activated areas, and blocking at least partly light from non-activated areas. Areas that are activated (i.e. emit light) are then visible, whereas non-active areas are black. Such a means can strongly increase the contrast. The means shuts out light from non-activated areas and transmits light from activated areas. The intensity of the image itself is not reduced or reduced to a small amount only, whereas the intensity of the reflected light can be strongly reduced.

However, display panels have a large area, and the LC shutters need to have correspondingly large areas, which makes them very expensive. Moreover, the use of frames for the assembly makes the devices extra expensive, while, due to the frames, the optical coupling between the LC shutter and the display panel is not optimum, giving rise to unwanted reflections.

The LC shutters that are currently made are constructed from glass cells. To this end, thereto glass plates are covered with (structured) transparent electrodes usually made of ITO. They are coated with thin polyimide or alternative films to establish the liquid crystal orientation. Optionally, the glass plates may be provided with color filters, a black matrix, planarization layers, passivation layers, etc. In the case of special applications, also some logic may be introduced on the plate. After having undertaken all the coating and lithographic procedures to apply these films, the glass plates are adhered together with an accurately placed adhesive stripe. Previously applied spacers, e.g. glass or plastic spheres or fibers, should maintain the cell gap of conventional LC shutters at a constant value between 10 and 20 μm. The adhesive seal is left with some openings that are used to fill the cells with liquid crystal in a vacuum process.

The whole process of cell making and filling is a laborious, batch-wise, time-consuming (only filling of the larger cells already takes hours), and therefore a relatively expensive process that largely determines the cost price of an LC shutter. In addition, the cell-based designs are relatively thick because of the thickness of the two glass plates that are involved.

Basic Principle of the Invention

This invention aims to provide a design, a methodology and the materials to make liquid crystal shutters, following a completely different route than currently applied and described above. This new technology is basically cheaper because of processing time. It also aims to provide a method that is flexible for new designs and new materials. For example, it can be used as easily on glass substrates, on plastic substrates as well as on substrates with more complex architectures. It also aims to provide a method that, in general, could lead to basically thinner shutters.

In the light of the foregoing, it is a first object of the invention to provide an LC shutter which can be made in an inexpensive way and can be assembled in an inexpensive way with a display panel.

The above object is solved by a picture display device having a display panel with an active part on which pictures are displayed, an LC shutter of a size corresponding to the size of the active part of the display panel being arranged in front of the display panel, electrode means being provided for energizing the LC shutter, characterized in that the LC shutter comprises:

a transparent substrate which carries a composite material phase separated into a light-modulating layer comprising liquid crystal material disposed adjacent the substrate, and a top layer of organic material, inorganic material, or a mixture of organic and inorganic material disposed adjacent the display panel, the LC shutter being fixed to the surface of the display panel, for example, by an adhesive.

The basis for the invention is a mixture of a liquid crystal and a polymer forming material that has a rheology such that it can be coated as a thin film of controlled thickness on a glass or plastic substrate, preferably provided with transparent electrodes and an orientation layer. Upon a certain action, which might be, for instance, an UV exposure or heat, or just spontaneously at the appropriate moment, the single layer phase separates into two distinguishable layers. The bottom layer that is formed closest to the substrate and the electrodes consists completely or almost completely of liquid crystal. The top layer that is formed at the interface with air is a polymer top coating with solid mechanical properties. The liquid crystal layer has the property that the liquid crystal molecules are organized in a preferred molecular arrangement such that desired optical properties are obtained. The top layer is mechanically stable and strong such that it replaces, for instance, the glass surface of the current liquid crystal cells.

As the top layer is stable, the LC shutter can be bonded to the display panel such that the top layer is on the outer side of the assembly. However, in accordance with a preferred embodiment, the top layer is fixed to the surface of the display panel by means of an adhesive, whereby the substrate, which may be a glass plate or a synthetic material plate, is on the outer side. In this manner, the phase-separated composite material is optimally protected. In both situations, an optimum optical coupling can be realized.

The adhesive may be a cured resin, e.g. an epoxy type material, an acrylic, or methacrylic type material, or mixtures thereof, a silicon resin or a gel, but the invention is not limited to these materials.

A simple bonding of the LC shutter to the display panel is warranted in the case where the surface of the display panel is flat, which is the case in most modem picture display devices, PDPs, LCDs and even CRTs (RF-Real Flat-types).

The bonding step is further simplified if a seal adjacent the periphery of the top layer or the surface is arranged between the display panel and the opposing surface of the LC shutter (which may be a surface of the top layer or a surface of the substrate), so that the space between the display panel, the seal and the top layer or the substrate can be filled with a liquid adhesive, preferably of a type which can be cured (by exposure to heat or UV radiation or by reaction of two previously mixed reactive components) thereafter.

In accordance with a further aspect, the LC shutter comprises an electrode layer arranged on the substrate facing the light-modulating layer, the optical transmittance of the shutter being switchable between an open and a closed state under the influence of an electric power source which is connectable to said electrode layer. This type of switching (called in-plane switching) necessitates only one electrode layer, which promotes the feasibility of the present single substrate concept. An alternative is to arrange a second electrode layer on the surface of the top layer, whereby conventional (perpendicular) switching is possible.

In accordance with a further aspect, the light-modulating layer comprises an LC-gel which can be switched between a transmissive and an opaque state, and more in particular the LC-gel comprises an oriented polymer network, LC material having a predetermined Δε being comprised in cavities of the network. In the case of an in-plane switching electrode configuration, the polymer network may comprise an LC material having a negative Δε in its cavities, but the use of a material having a positive Δε is preferred. It has been found that a material system of this type can provide a shutter which can be switched between transmitting and (milky white) scattering. No polar is needed to bring about this effect, so there is no loss of light and the costs of polars are saved. Moreover, LC-gels are transparent if no voltage is supplied to the LC cell. Consequently, they are fail-safe.

In the case of a perpendicular switching electrode configuration, an LC material having a negative Δε and a (pleochroic) dye may be comprised in the cavities of the network. It has been found that the latter system can be switched between a transmitting and an absorbing state.

Apart from the above materials, which are called permanent LC-gels, physic gels or polymer-dispersed liquid crystals may be used, but the invention is not limited to these and the above materials.

The invention provides, inter alia, a means to hide a CRT, or other display type like plasma panel or LCD, by a switchable panel (LC shutter or switch) bonded to the front of the display. This feature can be used to make a TV-screen invisible when it is not turned on, whereas undisturbed TV viewing is possible in the transparent state of the panel. The switchable panel should be transparent in the open state, the closed state should hide the object behind. The closed state may therefore be strongly absorbing (e.g. black) or scattering (e.g. milky white, mat). For design reasons, a milky white appearance is preferred. In another application, the LC panel forms a light modulator which can be driven to alternate the polarization direction of transmitted light. To this end, a polarizing filter is applied in between the front of the display and the top layer of the light shutter. In this manner, a switch for e.g. stereoscopic viewing of CRT images is provided.

Another positive aspect of the above specific LC-gels is the fast switching time (around 1 ms), which is more than fast enough for the envisaged application. Moreover, their application is ‘fail safe’: in case of electric breakdown, the light-modulating layer becomes transparent thus allowing TV viewing. In the active scattering state, the power consumption is low (<1 W for 32″WSRF dimensions).

In order not to disturb the picture in the open state, the LC light modulator element should be in optical contact with the display screen of, for example, a CRT, a plasma panel or a LCD. In this way, the specular reflections of modulator element-air and display screen-air interfaces are avoided.

It is therefore desirable to combine the modulator element and, for example, a CRT by means of lamination. A lamination process is advantageous in which a cast resin is used as the coupling medium between modulator element and CRT. This lamination technology is in particular suited to optically couple a LC shutter on a Real Flat CRT screen.

These and further aspects of the invention will be explained in greater detail by way of example and with reference to the accompanying drawings, in which

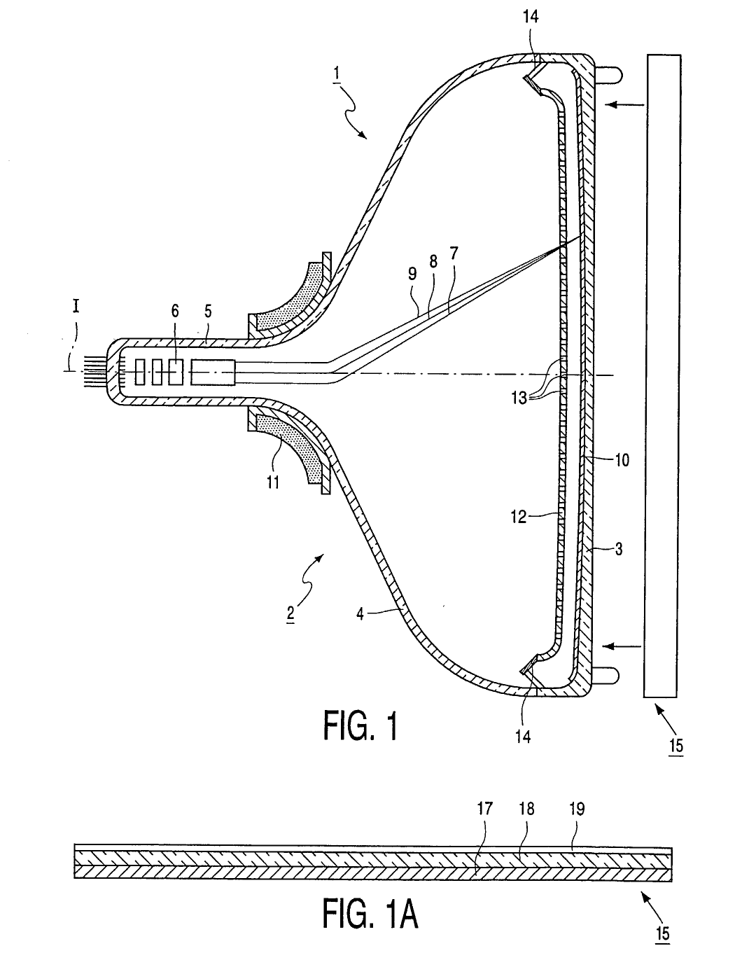

FIG. 1 shows schematically a display device with LC shutter in a cross-section.

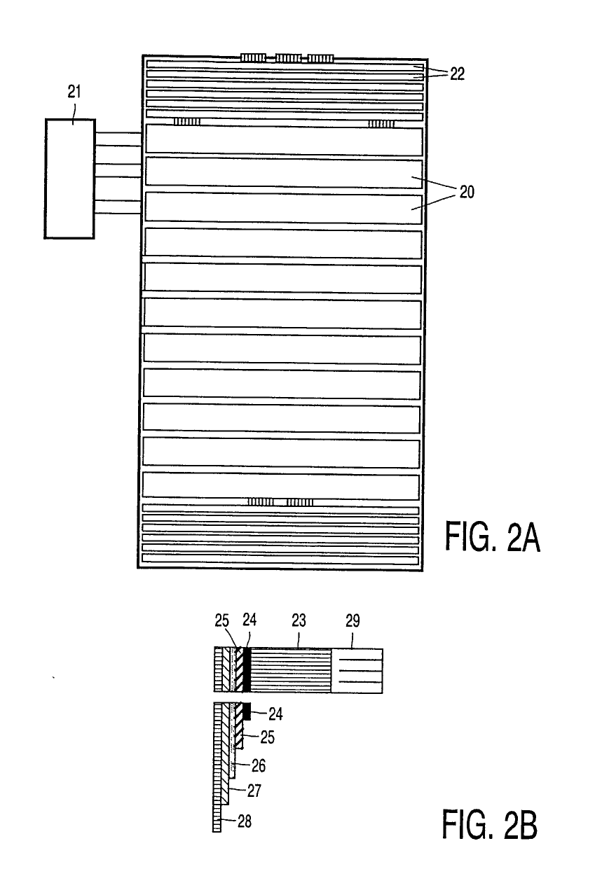

FIG. 2A shows schematically a top-view of a means for use in scanning window applications.

FIG. 2B shows schematically an LC cell.

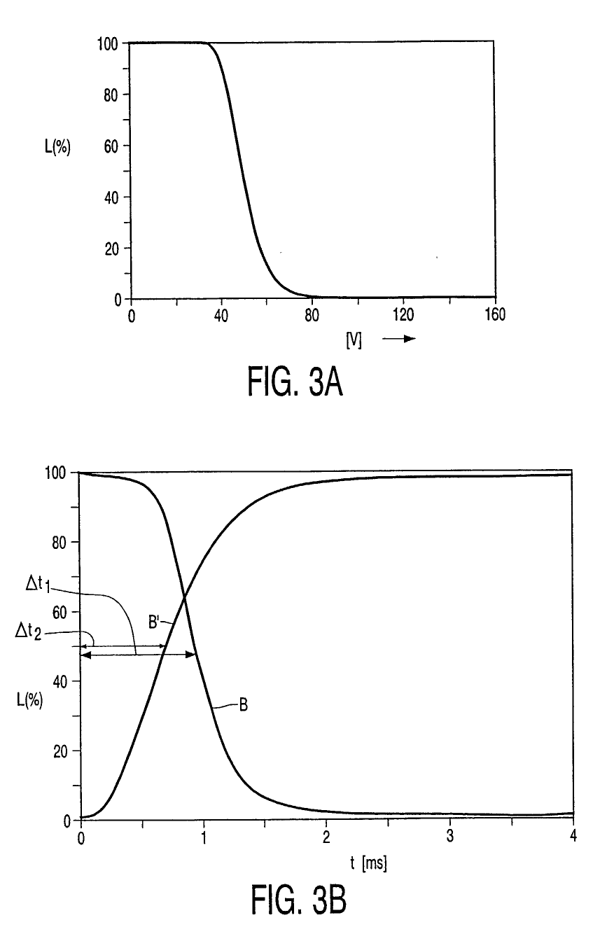

FIG. 3A illustrates the relative luminance of an image behind the LCD cell as a function of voltage across the cell.

FIG. 3B illustrates the switching times both for active and passive switching.

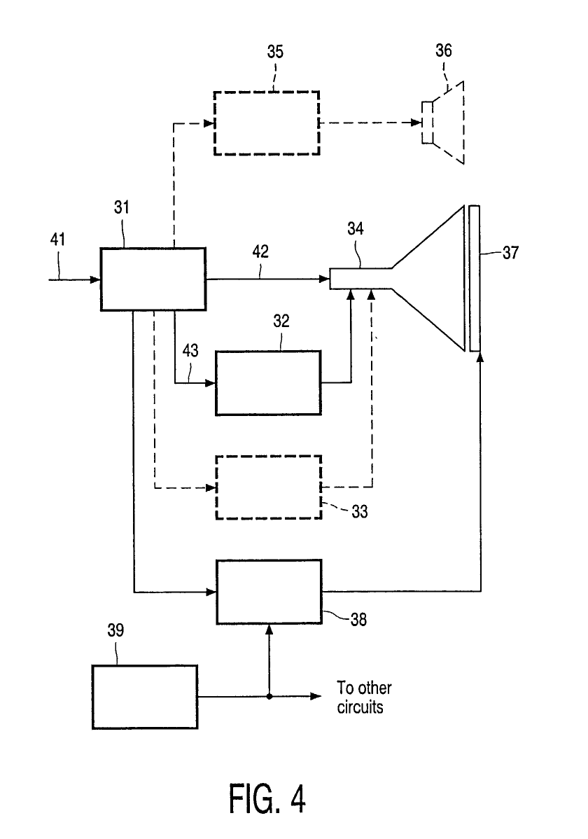

FIG. 4 shows a simplified block diagram of a display apparatus.

The Figures are not drawn to scale. In general, like reference numerals refer to like parts.

A color display device 1 (FIG. 1) includes an evacuated envelope 2 comprising a display window 3, a cone portion 4 and a neck 5. Said neck 5 accommodates an electron gun 6 for generating three electron beams 7, 8 and 9. A display screen 10 is present on the inner side of the display window. Said display screen 10 comprises a phosphor pattern of phosphor elements luminescing in red, green and blue. On their way to the display screen, the electron beams 7, 8 and 9 are deflected across the display screen 10 by means of a deflection unit 11 and pass through a shadow mask 12 which is arranged in front of the display window 3 and comprises a thin plate having apertures 13. The shadow mask is suspended in the display window by means of suspension means 14. The three electron beams converge and pass through the apertures of the shadow mask at a small angle with respect to each other and, consequently, each electron beam impinges on phosphor elements of only one color. In FIG. 1, the axis (z-axis) of the envelope is also indicated. A shutter means 15 for transmitting and scattering, or absorbing, light is arranged in front of the display window 3.

An embodiment of the shutter means 15 is shown in more detail in FIG. 1A. In this case, the shutter means is of the single substrate type, as can be manufactured by using the phase separation, or stratification, process. Transparent substrate 17 carries a composite material phase separated into a light modulating layer 18 comprising liquid crystal material and a top layer 19 of e.g. polymeric material.

Liquid Crystal (Self) Stratification Process

Essential in the manufacture of stratified LCDs is the formation of the layers. The following general procedure has been developed.

1. A homogeneous mixture is made from the liquid crystal material, a monomer, a photoinitiator and an absorber. The mixture is not necessarily liquid crystalline itself; normally the LC phase is lost when the liquid crystal material is blended with larger quantities of non-liquid crystalline material such as a monomer. This is not essential for the process.

2. In general, the liquid crystal material is a complex mixture to optimize on a broad set of properties. In order to prove the validity of this invention, most experiments so far have been performed with E7 (Merck) which is a relatively simple mixture of three so-called cyanobiphenyls and a cyanoterphenyl that has a broad liquid crystal temperature range, a high birefringence and a high dielectric constant.

3. Also the monomer may consist of several materials e.g. from the classes of acrylates, epoxides, thiolenes and/or vinylethers. Most experiments have been performed with mono and di-acrylates, e.g. isobornylmethacrylate and tripropyleneglycoldimethacrylate.

4. A typical ratio between (meth) acrylate monomer and liquid crystalline material is 50/50 w/w. However, to control LC-layer thickness, also other concentrations are possible, e.g. the liquid crystal content may vary between 10 and 90 w %.

5. The photoinitiator and the absorber must be a very balanced mix. The photoinitiator produces the reactive particles, e.g. free radicals, upon exposure to UV or near UV visible light. The absorber has the function that, near the top of the film, most reactive particles are formed such that a solid polymer film upon formation phase separates near the interface with air (or another gas when flushed with an inert gas).

6. The viscosity of the liquid mixture is optimized such that a stable wet film can be applied on a glass or other substrate, e.g. by using a doctor blade, a knife coating or slot die coating. It is very essential that the film thickness is constant throughout the surface area. A typical film thickness is between 5 and 50 μm but may be anything between 2 and 200 μm although this will affect the stratification process and will determine the initial ratio between monomers and liquid crystal.

7. Breaking up the wet film into the liquid crystalline bottom and the polymeric top layer, the actual stratification process, is enforced by UV exposure and consequent polymerization of the monomers. The dye provides a steep intensity drop of UV light over the thickness of the initial film, yielding a large difference in polymerization rate between the top and the bottom of the film. The polymer is therefore predominantly formed in the upper part of the film. Therefore, the monomer is depleted in this part. The non-reacted monomers still present in the lower part diffuse, driven by the consequent concentration differences, to the upper part where they are attached to the growing polymer.

Special Embodiments for Enhancing the Stratification Process

1. In a special embodiment of the invention the added dye is photobleaching upon UV exposure. This allows a high absorption and a very steep intensity gradient of the UV light in the initial state of UV exposure. When the polymerization proceeds in the very upper layer of the film, the dye bleaches, which also allows polymerization in the deeper sections and ultimately a complete conversion of the monomer into polymer.

2. In another embodiment, no dye is added at all, but the wavelength for photopolymerization is chosen to be such that the own absorption of the mixture establishes the intensity gradient. This will especially be the case when wavelengths below 320 nm are chosen or when special liquid crystals (e.g. higher concentrations of cyanoterphenyls or anthrachinon containing liquid crystals) or special monomers (e.g. anthracene containing acrylates) are used.

3. In again a special case, the monomer will be absorbing at higher wavelengths and will be photobleaching upon exposure. This will, for instance, be the case with special stilbene diacrylates that undergo so-called E-Z isomerization with a corresponding shift in absorption wavelengths. In practice, this method has proved to be most valid procedure until now.

4. In again another embodiment, the photoinitiator will be strongly absorbing in the initial state and photobleaching upon exposure. Examples are photoinitiators based on maleimides.

5. Of course, also combinations of these special embodiments are possible.

Special Embodiments for Controlling Liquid Crystal Orientation

The process inherently allows LC orientation control from only the substrate side of the liquid crystal. To this end, the substrate may be coated with a thin polyimide coating that is rubbed prior to application of the LC/monomer film. In general, this one-surface enforced alignment is already sufficient to establish uniaxial alignment. Alternatively, other polyimide-types or special surfactants might provide uniaxial homeotropic (=perpendicular to the substrate surface) orientation. The addition of chiral liquid crystal dopants to the mixture will result in twisted structures comparable to those in TN or STN displays.

Sometimes it is desired to take special measures from the side of the hard topcoat to enhance the control over the molecular orientation:

1. Special surfactant-like monomers can be added to the mixture. Examples are alkylacrylates with an alkyl tail longer than four units (e.g. ethylhexylacrylate), fluorinated alkylacrylates, alkylthiols, etc. These additives will preferentially cause a homeotropic (perpendicular) orientation of the LC molecules at this interface.

2. Special monomer combinations might provide planar orientation by a process of photoalignment. For example, when the stratification of a special azo-containing monomer combination is enforced by exposure with polarized UV light, not only photopolymerization but also a re-orientation of the average molecular orientation in the polymers takes place. This preferential orientation in general orients the liquid crystals near that layer into a direction perpendicular to the E-field of the UV light.

Special Embodiments for Generating a Light Modulator

The principle of manufacturing light modulator elements by means of the stratification process can be applied to a variety of liquid crystal effects. In general, it is preferable to select liquid crystal effects that can operate with electrodes at only one side of the LC film, i.e. at the glass or plastic substrate. It that case, really cost-effective display manufacturing is possible. Various possibilities are possible within these so-called in-plane switching configurations. Examples are:

In-plane switching from a homeotropic LC to a planar alignment. This effect requires a polarizer at both sides of the stratified cell.

The same effect, but now with a dichroic dye added as guest to the liquid crystal host.

One of the polarizers or both polarizers can now be omitted.

In-plane switching of planar LC in plane of the film. This effect requires a polarizer at each side and may in principle be very independent of the viewing angle.

Also here, a guest-host switching effect can be obtained by adding a dichroic dye to the liquid crystal mixture.

A cholesteric liquid crystal that provides CTLC-type of LCD effects with in-plane switching. Also here, the polarizers can be omitted.

In another design, the electrodes are applied at both sides of the liquid crystal layer. To this end, the polymer topcoat needs to be coated with a transparant conductive layer. ITO is the most obvious choice but the application processes of ITO layers, e.g. by sputter coating, are difficult to combine with the organic double layer. As an alternative, organic conductors such as the polyaniline or PEDOT may be considered.

In the case of electrodes at both sides, all LCD effects can be generated and applied, ranging from TN, STN, ECB, and OCB to vertical alignment, multi-domain effects, etc. However, because of the presence of the polymer topcoat, the switching voltages will be higher than in the similar glass-cell based counterparts. To reduce the switching voltages, the topcoat thickness must be made as thin as possible. After the application of the conductor, an additional topcoat might be applied.

Additional Layers on the Stratified Polymer Film

The sequence of the various processing steps allows the addition of other components such as:

Scratch resistance top layers can be easily brought on top of the stratified polymer film to enhance the mechanical properties of the display.

Barrier coating when the display is expected to be used at higher temperatures to avoid evaporation of the liquid crystal.

Coatable polarizers, e.g. ones that are currently being developed and are based on the Optiva technology that can be blade-coated in-line after stratification. The combination of stratified LC cells and the coatable polarizers will lead to extremely cost-effective displays.

FIG. 2A is a top view of a scanning window application of means 15. The means comprises a plurality of single substrate LC cells 20 (“sub-shutters”) and means 21 for controlling the transmission characteristics of the LC cells. Each cell is opened, i.e. transmissive to light emanating from the display window when the area behind the cell is activated, i.e. emits light. It is to be noted that the example in FIG. 2A comprises a number of cells, and that it is also possible, and indeed advantageous to use a single cell having a large number of opposing electrodes (for instance, many pairs of opposing electrodes). Application of proper voltages will then switch the areas between the pairs of electrodes between a transmissive and a blocking state. Instead of a plurality of “sub”-shutters, one integral stratified shutter may be used advantageously. In the latter case, the switchable material may be arranged between a continuous electrode and a patterned electrode.

FIG. 2B illustrates schematically an LC shutter for use in the invention. The LC shutter comprises a polymer top layer 29, an LC material 23 which comprises in a oriented polymer network an LC material with predetermined Δε and a (pleochroic) dye, transparent electrodes (for instance, made from ITO) 26, a barrier layer 25, a polyimide layer 24, a (e.g. glass) substrate 27 and optionally an anti-reflection layer 28. Depending on the combination of electrode configuration and alignment layer, the sign of Δε is selected to be positive or negative. In a number of cases, e.g. where the electrodes are on the same side of the LC material, a positive Δε is preferable.

FIG. 3A shows the relative luminance (L in percentage on the vertical axis) as a function of the voltage applied on the electrodes (V in Volts on the horizontal axis. When the shutter is in the transmissive state (L=95% in a practical embodiment) application of a voltage of approximately 80 Volts will close the shutter, the light-modulating layer of which in this example has a thickness of 18 micrometer, and comprises 7% (by weight) of an oriented polymer network. By application of a voltage of a sufficiently high amplitude, the LC shutter can therefore be closed. The time needed for ‘closing’ is herein called the ‘active switching time’ Δt₂. For a proper functioning, the shutter, however, also has to be opened at some time. This is done by removing the voltages across the electrodes. The LCD material will then convert back to the ‘transmissive state’ passively, i.e. not driven by outside voltages. The oriented polymer network is oriented in such manner that the LCD material experiences an internal force driving the LCD material to the ‘transmissive state’. The time needed to open a cell is herein called the passive switching time Δε,.

FIG. 3B illustrates, as a function of time, the closing of a shutter (falling slope: B) and opening of a shutter (rising slope: B¹). These slopes are drawn for 80 Volts. The switching times (i.e. the time needed to arrive at a point half-way between two states) Δt₁ and Δt₂ for opening and closing a shutter are also indicated in the Figure. It can be seen that the opening and closing time are both of the order of 1 millisecond.

Using a light-modulating layer in the stratified LC shutter, which layer comprises an oriented polymer matrix, an LC material with predetermined Δε and a (pleochroic) dye, it is possible to obtain values for Δt₁ (to ‘open’ the shutter) and Δt₂ (to ‘close’ the shutter) of less than 2, preferably less than 1 millisecond. Less than 1 milliseconds is in particular suited for devices which operate at more than 50 Hz.

The same shutter, but without a (pleochroic) dye in its ‘closed’ state scatters light very efficiently. Thus, such a system seems to be very attractive for “integral” LC shutter applications, which enable the TV screen to be “hidden” or shown.

The content of the oriented polymer matrix preferably lies between 5 and 15%. Lower percentages yield relatively large passive switching times, whereas higher percentages yield a relatively high luminance, even in the closed state.

The invention further relates to a display apparatus as defined in claim 13. A simplified block diagram for such a display apparatus in shown in FIG. 4. Input display data 41 is supplied to the videodetector 31. The sound portion of the data is provided to the sound channel 35 which reproduces the sound in speaker 36. The videodetector 31 further provides a display drive signal 42 to the picture display device 34 and synchronizing signals 43 to the addressing means 32. For a CRT, these addressing means 32 comprise deflection circuits for line and frame deflection. For other picture displays, such as LCD or PDP, these addressing means 32 may provide matrix addressing circuits for line and row addressing. If a color signal is present, special color circuit demodulators 33 are present as shown by the dashed lines in FIG. 4.

The embodiment of the display embodiment of FIG. 4 further comprises a picture display device 34 having a display panel with an active part on which pictures are displayed, an LC light modulator element 37 of a size corresponding to the size of the active part of the display panel being arranged in front of the display panel, the LC light modulator element being provided with transparent electrode means allowing energization of the LC light modulator element 37, the energization being dependent on the operation of the display device 34, wherein the LC light modulator element 37 includes a stratified LC light modulator element of the type described above, and wherein the display apparatus comprises a control means 38 for switching the LC light modulator element 37, and a power supply 39 for energizing the LC light modulator element 37. Power supply 39 may also be used to supply power to other circuits.

In summary, the invention relates to a display device having a display panel with an active part on which pictures are displayed, a stratified (LC) light modulator element (e.g. a shutter or a switch) of a size corresponding to the size of the active part of the display panel being arranged in front of the display panel, the light modulator element being provided with transparent electrode means allowing energization of the LC light modulator element. The stratified LC light modulator element comprises:

a transparent substrate which carries a composite material phase separated into a light modulating layer comprising liquid crystal material disposed adjacent the substrate, and a top layer of organic material, inorganic material, or a mixture of organic and inorganic material disposed adjacent the display panel, the IC light modulator element being laminated to the surface of the display panel.

1. A display device having a display panel with an active part for displaying pictures, an LC light modulator element of a size corresponding to the size of the active part of the display panel being arranged in front of the display panel, the light modulator element being provided with transparent electrode means allowing energization of the LC light modulator element, characterized in that the element comprises:
a transparent substrate which carries a composite material phase separated into a light modulating layer comprising liquid crystal material disposed adjacent the substrate, and a top layer of organic material, inorganic material, or a mixture of organic and inorganic material disposed adjacent the display panel , the element being fixed to the surface of the display panel.

2. A display device as claimed in claim 1, characterized in that the top layer of the element is fixed to the surface of the display panel by means of an adhesive.

3. A display device as claimed in claim 1, characterized in that a seal is arranged between the surface of the display panel and one of the top layer and the substrate of the element adjacent the periphery of said one of the top layers and the substrate, the space enclosed by the display panel, the seal and said one of the top layers and the substrate being filled with an adhesive.

4. A display device as claimed in claim 1, characterized in that the element further comprises an electrode layer arranged on said substrate facing the light-modulating layer, the optical transmittance of the element being switchable between an open and a closed state under the influence of an electric power source which is connectable to said electrode layer.

5. A display device as claimed in claim 1, characterized in that the element can be set either to an open transparent, state, or to a closed, light-scattering, state.

6. A display device as claimed in claim 1, characterized in that the element can be set to either an open, transparent state, or to a closed, light-absorbing, state.

7. A display device as claimed in claim 6, characterized in that the element forms a scanning window.

8. A display device as claimed in claim 1, characterized in that a light modulator element can be driven to alter the polarization direction of transmitted light.

9. A display device as claimed in claim 1, characterized in that the element closes (becomes opaque) when the element is energized.

10. A display device as claimed in claim 9, characterized in that the element opens (becomes transparent) in case of break down

11. A display device as claimed in claim 1, characterized in that the electrode means are adapted for in-plane switching, and in that the light-modulating layer comprises a polymer network having an LC material with a positive Δε in its cavities.

12. A display device as claimed in claim 1, characterized in that the electrode means are adapted for perpendicular switching, and in that the light-modulating layer comprises a polymer network having an LC material with a negative Δε and a dye in its cavities.

13. A display apparatus comprising a display device having a display panel with an active part for displaying pictures, an LC light modulator element of a size corresponding to the size of the active part of the display panel being arranged in front of the display panel, the light modulator element comprising transparent electrode means allowing energization of the LC light modulator element, wherein the LC light modulator element comprises a transparent substrate which carries a composite material phase separated into a light modulating layer comprising liquid crystal material disposed adjacent the substrate, and a top-layer of organic material, inorganic material, or a mixture of organic and inorganic material disposed adjacent the display panel, the element being fixed to the surface of the display panel, and wherein the display apparatus comprises a control means for switching of the LC light modulator element, and a power supply for energizing the LC light modulator element.
